(19) United States
(12) Patent Application Publication
(10) Pub. No.: US 2004/0080479 A1
(43) Pub. Date: Apr. 29, 2004

(54) Sub-pixel arrangements for striped displays and methods and systems for sub-pixel rendering same

(76) Inventor: Thomas LIoyd Credelle, Morgan Hill, CA (US)

Correspondence Address: Finnegan, Henderson, Farabow,, Garrett & Dunner, L.L.P., 1300 I Street, N.W., Washington, DC, 20005-3315, US

(21) Appl. No.: 10/347,001

(22) Filed: Jan. 16, 2003

Related U.S. Application Data
(63) Continuation-in-part of application No. 10/278,353, filed on Oct. 22, 2002.
(63) Continuation-in-part of application No. 10/278,352, filed on Oct. 22, 2002.

(51) Int. Cl. G09G 3/36

(52) U.S. Cl. 345/88

(57) ABSTRACT

Various embodiments of a sub-pixel grouping are disclosed for displays comprised of color stripes. One embodiment comprises a quad grouping that further comprises three-color sub-pixels with one colored sub-pixel comprising twice the number of positions within the quad sub-pixel grouping as the other two colored sub-pixels. Various embodiments for performing sub-pixel rendering on the sub-pixel groupings are disclosed.

### RELATED APPLICATIONS

This application is a continuation-in-part of U.S. patent application Ser. No. 10/278,353(“the ‘353 application”), entitled “IMPROVEMENTS TO COLOR FLAT PANEL DISPLAY SUB-PIXEL ARRANGEMENTS AND LAYOUTS FOR SUB-PIXEL RENDERING WITH INCREASED MODULATION TRANSFER FUNCTION RESPONSE,” filed on Oct. 22, 2002, and U.S. patent application Ser. No. 10/278,352 (“the ‘352 application”) entitled “IMPROVEMENTS TO COLOR FLAT PANEL DISPLAY SUB-PIXEL ARRANGEMENTS AND LAYOUTS FOR SUB-PIXEL RENDERING WITH SPLIT BLUE SUB-PIXELS,” filed on Oct. 22, 2002. The ‘352 and ‘353 applications are hereby incorporated herein by reference and commonly owned by the same assignee of this application.

### BACKGROUND

In commonly owned U.S. patent application Ser. No. 09/916,232 (“the ‘232 application”—herein incorporated by reference) entitled “ARRANGEMENT OF COLOR PIXELS FOR FULL COLOR IMAGING DEVICES WITH SIMPLIFIED ADDRESSING” to Elliott as well as in the ‘352 application and the ‘353 application, novel sub-pixel arrangements are therein disclosed for improving the cost/performance curves for image display devices, particularly when coupled with sub-pixel rendering systems and methods further disclosed in those applications and in commonly owned U.S. patent application Ser. No. 10/051,612 (“the ‘612 application”—herein incorporated by reference) entitled “CONVERSION OF RGB PIXEL FORMAT DATA TO PENTILE MATRIX SUB-PIXEL DATA FORMAT”; and in commonly owned U.S. patent application Ser. No. 10/150,355 (“the ‘355 application”—herein incorporated by reference) entitled “METHODS AND SYSTEMS FOR SUB-PIXEL RENDERING WITH GAMMA ADJUSTMENT”; and in commonly owned U.S. patent application Ser. No. 10/215,843 (“the ‘843 application”—herein incorporated by reference) entitled “METHODS AND SYSTEMS FOR SUB-PIXEL RENDERING WITH ADAPTIVE FILTERING”.

The image displays devices in those applications require primarily that color assignments of sub-pixels are not continguous in either the horizontal or vertical directions across the display. The sub-pixels are typically arranged in a repeating sub-pixel cell structure that places at least two different colors on a checkerboard pattern. However, there are some display technologies—notably plasma displays and Red, Green, Blue (RGB) striped Liquid Crystal Display (LCD) displays)—wherein the colors run in a substantially continguous bands or “stripes” across the length and/or breadth of the display. Those systems might also gain in cost/performance, if a sub-pixel arrangement and suitable sub-pixel rendering scheme were applied to such striped systems.

FIG. 1 shows a conventional striped display 100 with three-color sub-pixel elements (blue) 102, (red) 104 and (green) 106 running in substantially continguous bands or stripes down the columns of the display. Cell structure 110 comprises the three color sub-pixels and typically comprises a repeat cell structure running across the display. As mentioned earlier, display 100 could be constructed in any known technology such as, for example, an RGB striped Active Matrix Liquid Crystal Display (AMLCD), or a plasma display. In such systems, opportunities for sub-pixel rendering such a striped system are not optimal. For example, both Microsoft and Adobe have created ClearType® and CoolType® as two versions of sub-pixel rendering on such striped display systems, which only affect addressability in one dimension and which only work on text images.

### BRIEF DESCRIPTION OF THE DRAWINGS

The accompanying drawings, which are incorporated in, and constitute a part of this specification illustrate various implementations and embodiments disclosed herein.

FIG. 1 shows typical stripe display, as is known in the art.

FIG. 2 shows one embodiment of an arrangement of three-color pixel elements in an array disposed across a display in accordance with the principles of the present invention.

FIG. 3 shows one embodiment of a backplane of a display made in the manner of FIG. 2.

FIG. 4 shows one embodiment of a dot inversion scheme of a RGB stripe AMLCD display system as made with the pixel arrangment of FIG. 2.

FIG. 5 shows another embodiment of a dot inversion scheme of a RGB stripe AMLCD display system as made with the pixel arrangement of FIG. 2.

FIG. 6 depicts one embodiment of a green color area resample grid for perfoming sub-pixel rendering on a striped display with a sub-pixel layout of FIG. 2.

FIGS. 7A-7C depict one embodiment of a red and blue area resample grid for performing sub-pixel rendering on a striped display with a sub-pixel layout of FIG. 2.

FIGS. 8A-8C depict another embodiment of a red and blue area resample grid for performing sub-pixel rendering on a striped display with a sub-pixel layout of FIG. 2.

FIG. 8D depicts yet another embodiment of area resample grids having a relative phase shift as compared with FIGS. 8A-8C.

FIGS. 9A-9B are alternative embodiments of sub-pixel arrangements for striped displays with a suitable relative shift between the green sub-pixels and the red and blue sub-pixels.

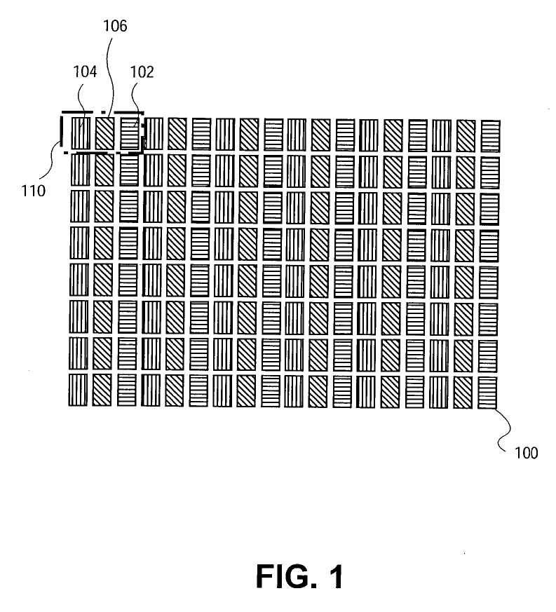

### DETAILED DESCRIPTION

Reference will now be made in detail to implementations and embodiments of the invention, examples of which are illustrated in the accompanying drawings. Wherever possible, the same reference numbers will be used throughout the drawings to refer to the same or like parts.

### Sub-Pixel Arrangements

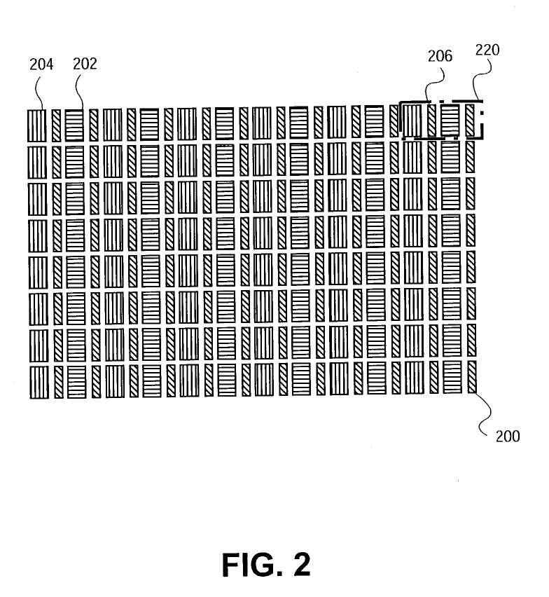

FIG. 2 shows one embodiment of an arrangement of sub-pixel emitters 200 comprising a four sub-pixel repeat cell structure 220 of three-color emitters across a display. As can be seen in FIG. 2, the respective colors—red 204, green 206, and blue 202—run down the columns of the display in a stripe fashion. Alternatively, the stripes could run along a row horizontally.

The stripes themselves could be comprised of individually addressable units, e.g., liquid crystal structures having their color filters placed in stripe fashion. The stripes may also comprise of colored emitter stripes, e.g., phosphor over plasma individual cells or electroluminescent materials arranged in stripes. The disclosed embodiments contemplate any set of addressable light-emitting, transreflective or translucent units, having colored stripes substantially running in a uniform color in some direction across a display.

As can also be seen in FIG. 2, the green sub-pixels 206 comprise two columns within the repeat cell structure 220. In this embodiment, these green sub-pixels may be narrower in at least one dimension than the red or the blue sub-pixels. Thus, the two sub-pixel emitters 206 could be reduced in size and aspect ratio compared to the other two sub-pixel emitters 204 and 202. The minority sub-pixels 204 and 202 may also be adjusted in aspect ratio. In this example, the relative size of sub-pixel 206 is adjusted to be one half of that of sub-pixels 204 or 202. Alternatively, other suitable sizing and aspect ratios could be applied to the three colored sub-pixels. As before, the colors may be assigned as desired. Furthermore, although the repeat quad grouping is shown with the majority color sub-pixels occupying the second and fourth columns, the majority sub-pixels could also occupy the first and the third columns as well.

In another embodiment, the colors are assigned as red 204, blue 202, and non-white balanced green 206. Since there are twice as many green 206 as there are of the other two colors, red 204 and blue 202, the result is a pleasing white point when all sub-pixels are illuminated fully.

In this or in another color assignment embodiment, the sub-pixel a aspect ratios may be adjusted so that the display array 200 consists of rectangular repeat cell groups with an aspect ratio of 1:2. This will put the majority color sub-pixel emitter 206 on a square grid. For an example of another color assignment embodiments, sub-pixels 206 could be assigned the color red and sub-pixels 204 could be assigned the color green in FIG. 2. Under this color assignment, the algorithms discussed below can be applied for sub-pixel rendering of any of the above described sub-pixel arrangements.

Not only may the green or the red sub-pixels occupy the majority colored sub-pixels in quad grouping 224, but the blue sub-pixels may also occupy the majority sub-pixels. Thus, all three colors—red, green, and blue—may occupy the majority sub-pixel position in this grouping. Additionally, while the colors—red, green and blue—have been used for the purposes of illustrating the disclosed embodiments, other suitable choice of three colors—representing a suitable color gamut for a display—may also be used.

As shown in FIG. 2, the sub-pixels appear to have a substantially rectangular appearance. Different shapes, however, may be used for the sub-pixels. For example, a multitude of other regular or irregular shapes for the sub-pixels are possible and are desirable according to their manufacturability. It suffices only that there is an quad grouping of striped colored sub-pixels in the fashion herein described that may be addressable for the purposes of sub-pixel rendering (SPR).

FIG. 3 illustrates a schematic for a driver arrangement 300 for the arrangement of color emitter sub-pixels in FIG. 2. For convenience, the example given has the same number of sub-pixels illustrated as FIG. 2. This drive arrangement may be used for a number of display technologies, as the blocks 310 may represent one or several electrical components, which are not shown so as not to obscure the embodiments. In particular, they may represent the capacitive display cell element for passively addressed Liquid Crystal Display (LCD), or ElectroLuminescent (EL) Display. They may represent the gaseous discharge element in a Plasma Display Panel (PDP). They may represent the semiconductor diode element of a passively addressed Inorganic Light Emitting Diode or an Organic Light Emitting Diode Display. They may also represent the transistor, storage capacitor, and capacitive cell element of an Active Matrix Liquid Crystal Display (AMLCD). They may further represent the multi-transistor, storage capacitor, and light emitting element of an Active Matrix Organic Light Emitting Diode Display (AMOLED). The may also represent, in general, the color sub-pixel and its associated electronic elements found in other known or yet to be developed display technologies.

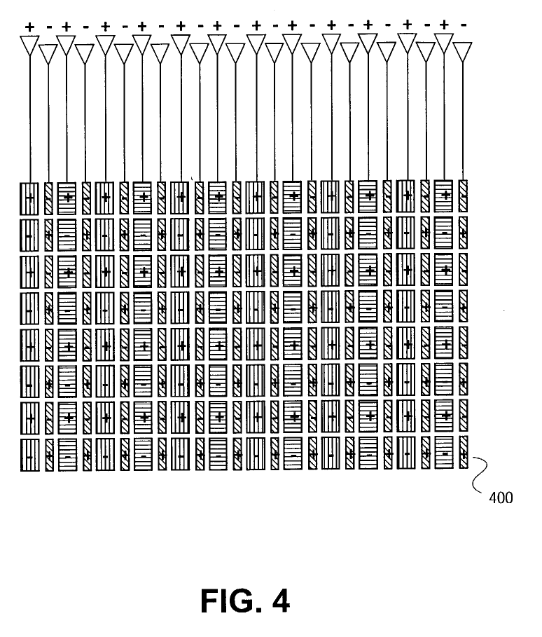

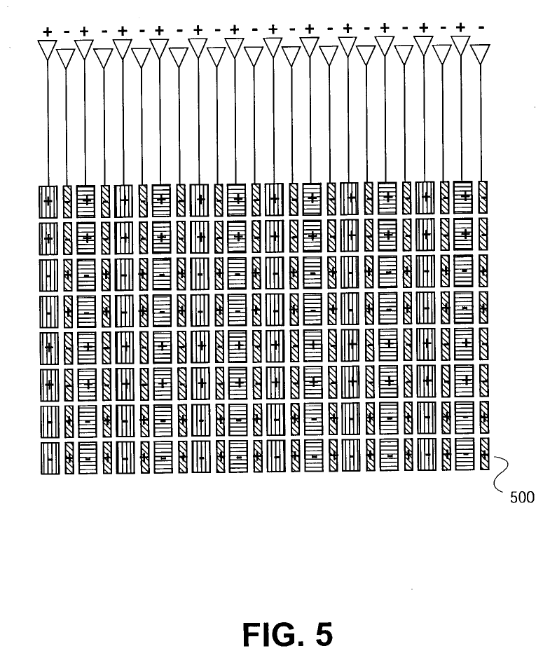

Inversion schemes, which involve selectively switching the electrical field polarity across the display cell to provide a time averaged zero net field and ion current across the cell, can be applied to the embodiments disclosed herein. FIGS. 4 and 5 show two “dot inversion” schemes 400 and 500, referred to as “1×1” and “2×1”, respectively, on Active Matrix Liquid Crystal Displays, both of which will perform satisfactorily. The scheme shown on FIG. 4 may perform better when slight imbalances of light transmission occur between positive and negative polarities, especially when the eye is tracking the motion of displayed images moving across the screen. Each of the Figures shows the polarities during half of the display addressing fields. The polarities are reversed for the other half, alternating every field, resulting in a net zero current (zero DC bias), as is well known in the art. Line inversion of polarity, by row or by column, can also be utilized.

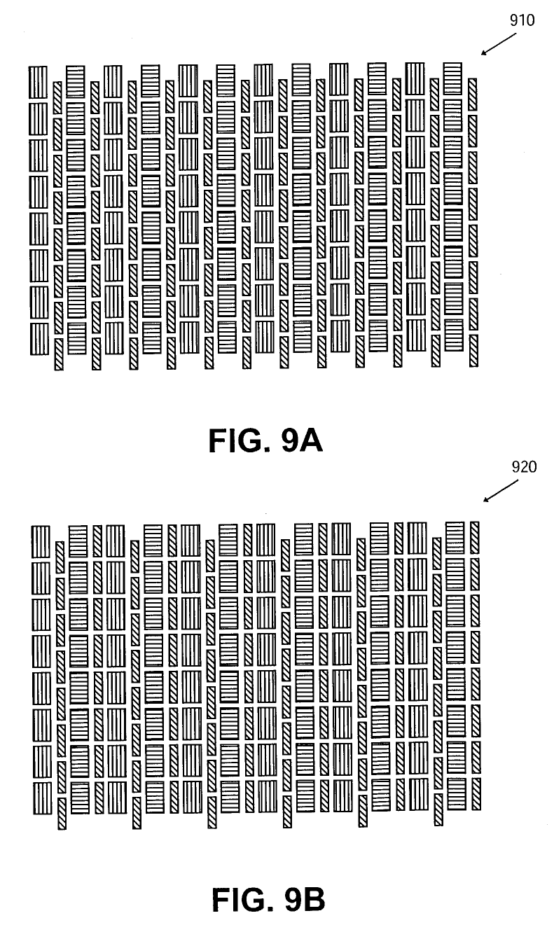

Other embodiments of the quad groupings are also possible. FIGS. 9A and 9B depict quad groupings wherein the majority sub-pixels 106 are shifted with respect to the stripes of red and blue sub-pixels. Other arrangements of majority sub-pixel placement within such a stripe scheme are also possible and are contemplated within the scope of the present invention.

Still other embodiments are possible. For example, the entire quad sub-pixel groupings may be rotated 90 degrees to reverse the roles of row and column driver connections to the grouping. Such a horizontal arrangement for sub-pixels is further disclosed in the co-pending U.S. patent application Ser. No. 10/278,393 entitled “COLOR DISPLAY HAVING HORIZONTAL SUB-PIXEL ARRANGEMENTS AND LAYOUTS,” and is incorporated herein by reference.

### Data Format Conversion

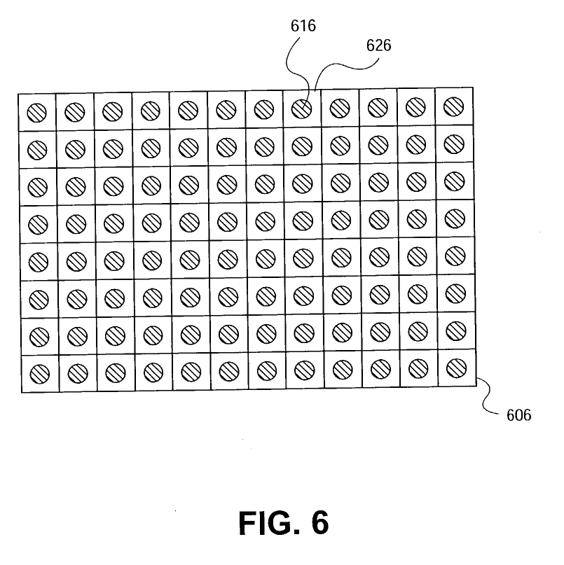

For data format conversion using area resampling techniques, FIGS. 6, 7A-7C, and 8A-8D illustrate various embodiments of green, blue, and red resample area arrays for the green, blue, and red color planes and their associated methods for data format conversion, as discussed below.

Each color resample area array includes resample areas, and each resample area has associated resample points associated with it. The resample points should match the relative positions of the green, blue, and red sub-pixel locations respectively, within each color plane; but not necessarily their exact inter-color-plane-phase relationships. Furthermore, any number of phase relationships are possible.

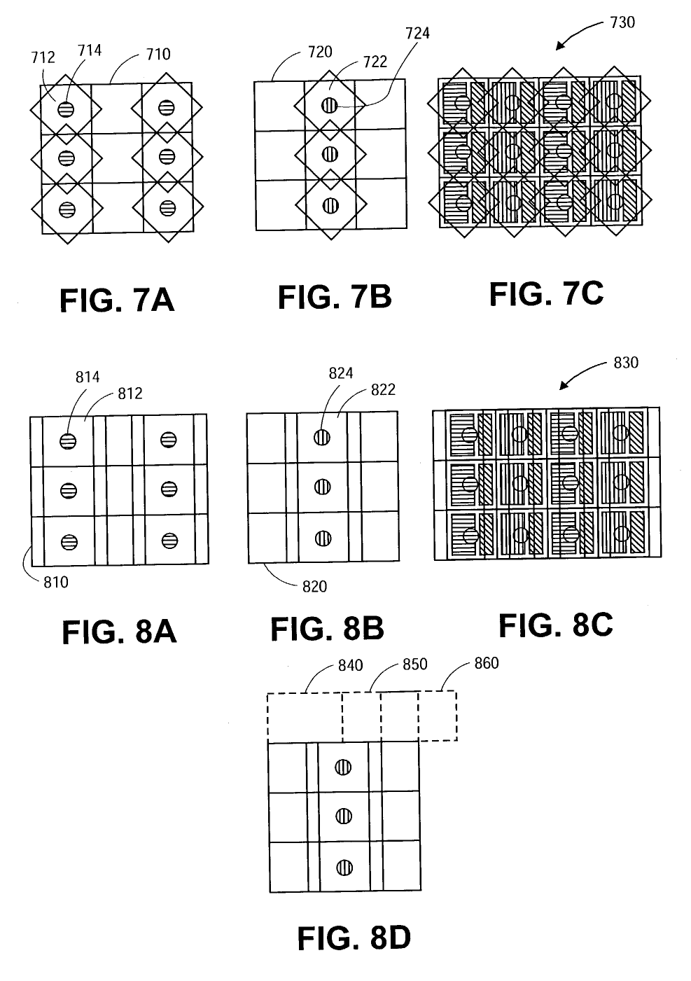

FIG. 6 illustrates one green area resample grid 606, in which each green resample area 626 has its own associated resample point 616. FIGS. 7A and 7B represent one possible area resample grids 710 and 720 for the blue and red colors respectively—each with its own resample areas 712, 722 and their associated resample points 714 and 724.

Using these particular area resample grids, they may be employed to convert the conventional fully converged square grid RGB format which is to be displayed “one-to-one” with the square green sub-pixel grid—as shown in FIG. 2. In one inter-color-plane-phase relationship, the green, blue, and red resample area arrays are substantially positioned such that the red and blue resample points overlap the green sample points. This treats the green sub-pixels as though they lay on top of, or intimately associated with, the red 104 and blue 102 sub-pixel stripes.

FIG. 7C shows one embodiment wherein the red and blue resample areas superimposed on the sub-pixel structure of FIG. 2. The green resample areas are not shown for clarity; but could be coincident with the red and blue resample points as discussed above. Other resample areas can be used and superimposed on alternative sub-pixel structures as shown in FIGS. 9A and 9B.

FIGS. 8A, 8B, and 8C illustrate another embodiment of red and blue resample grids 810 and 820, respectively, with their resample areas 812 and 822 and their associated resample points 814 and 824. FIG. 8C shows these red and blue resample areas superimposed on the sub-pixel structure of FIG. 2. This can be applied to the sub-pixel structures shown in FIGS. 9A and 9B as well. Furthermore, these Figures are merely illustrative and only serve to provide an understanding of the relationship between the resample points, reconstruction points, resample areas, and sub-pixel locations for these embodiments.

FIG. 8D shows another alternative embodiment for the area resample grids shown in FIGS. 8A-8C. In particular, FIG. 8D shows how a color (e.g. blue) area resample grid can be suitable phase shifted—as indicated by dotted boxes 840, 850 and 860.

The above referenced ‘355 patent application describes the method used to convert the incoming data format to that suitable for the display. In such a case, the method proceeds as follows: (1) determining implied sample areas for each data point of incoming three-color pixel data; (2) determining the resample area for each color sub-pixel in the display; (3) forming a set of coefficients for each the resample area, said coefficients comprising fractions whose denominators are a function of the resample area and the numerators are a function of an area of each the implied sample areas that may partially overlap said resample areas; (4) multiplying the incoming pixel data for each implied sample area by the coefficient resulting in a product; (5) adding each the product to obtain luminance values for each resample area.

Examining a “one-to-one” format conversion case for the resample operation, the green plane conversion is a unity filter. The red and blue color planes use a 3×3 filter coefficient matrix, derived as explained in detail in the ‘355 application:

| | | |
|---|---|---|
| 0 | 0.125 | 0 |
| 0.125 | 0.5 | 0.125 |
| 0 | 0.125 | 0 |

FIGS. 8A and 8B show the alternative blue and red color plane resample area arrays—shown herein as box filters ([0.5 0.5])—to replace the blue and red resample area arrays of FIGS. 7A and 7B, respectively. Again, the green resample uses a unitary filter. The red and blue color planes use a very simple 1×2 coefficient filter: [0.5 0.5]

Adaptive filtering techniques can also be implemented with the pixel arrangements disclosed herein. An adaptive filter, similar to that disclosed in the co-pending and commonly assigned U.S. patent application Ser. No. 10/215,843 (“the ‘843 application”), entitled “METHODS AND SYSTEMS FOR SUB-PIXEL RENDERING WITH ADAPTIVE FILTERING,” filed on Aug. 8, 2002, which is hereby incorporated herein by reference, can be adopted so as not to require a gamma pipeline as described in the ‘355 application.

So, an adaptive filter test could be implemented as follows to test to see if a high contrast edge is detected: compare the green data (G) to a min value and a max value—if G<min or G>max, then a register value is set to 1, otherwise the register value is set to 0; compare the register values for three successive green data points to test masks to see if an edge is detected; if detected then take an appropriate action to the red and/or blue data—e.g. apply gamma or apply a new value or different filter coefficient.

The following table is illustrative of this embodiment:

| | | | |
|---|---|---|---|
| Data (for 3 successive points | 0.98 | 0.05 | 0.0 |
| Low Test (G < 0.1) | 0 | 1 | 1 |
| High Test (G > 0.9) | 1 | 0 | 0 |
| Compare low and NOT high | True | True | True |

For the example above, an edge has been detected and there is an array of options and/or actions to take at this point. For example, the gamma correction could be applied to the output of the box filter for red and/or blue; or a new fixed value representing the output required to balance color could be used; or use a new SPR filter.

The test for black lines, dots, edges and diagonal lines are similar in this case, since only three values are examined:

| | Register Value | | | Binary no. |
|---|---|---|---|---|
| 1. | 1 | 0 | 1 | 5 |
| 2. | 1 | 1 | 0 | 6 |
| 3. | 0 | 1 | 1 | 3 |

In the above table, the first row could represent a black pixel with white pixels on either side. The second row could represent an edge of a black line or dot. The third row could represent an edge of a black line in a different location. The binary numbers are used as an encoding for the test.

The test for white lines, dots, edges, and diagonal lines might be as follows:

| | Register value | | | Binary no. |
|---|---|---|---|---|
| 4. | 0 | 1 | 0 | 2 |
| 5. | 0 | 0 | 1 | 1 |
| 6. | 1 | 0 | 0 | 4 |

If the tests are true and the high and low tests are, for example, 240 and 16 (out of 255) respectively, then the output value for these edges using the box filter might be 128+/−4—or some other suitable value. The pattern matching is to the binary numbers shown adjacent to the register values. A simple replacement of 128 raised to an appropriate gamma power could be output to the display. For example, for gamma=2.2, the output value is approximately 186. Even though the input may vary, this is just an edge correction term so a fixed value can be used without noticeable error. Of course, for more precision, a gamma lookup table could likewise be used. In addition, a different value, but possibly similar, of correction could be used for white and black edges. Furthermore, as a result of detecting an edge, the red and/or blue data could be acted on by a different set of filter coefficients—e.g. apply a [1 0] filter (i.e. unity filter) which would effectively turn off sub pixel rendering for that pixel value.

The above tests were primarily for a green test, followed by action on red and blue. Alternatively, the red and blue can be tested separately and actions taken as needed. If one desired to only apply the correction for black and white edges, than all three color data sets can be tested and the result ANDed together.

A further simplification could be made as follows. If only two pixels in a row are tested for edges, then the test above is further simplified. High and low thresholding may still be accomplished. If [0 1] or [1 0] is detected, then a new value could be applied—otherwise the original value could be used.

One embodiment could be accomplished as follows (illustrated for the red): subtract the red data value, R_{n,} from the red value immediately to the left, R_{n-1,}; if the delta is greater than a predetermined number—say for example 240—then an edge is detected. If an edge is detected, one could substitute a new value, or apply gamma, output the value Rₙ to the display, or apply new SPR filter coefficients; otherwise, if no edge is detected, output the results of the box filter to the display. As either Rₙ or Rₙ₋₁ may be larger, the absolute value of the delta could be tested. The same simplification could occur for the blue; but the green does not need to be tested or adjusted, if green is the split pixel in the grouping.

Alternatively, a different action could be taken for falling edges (i.e. Rₙ−Rₙ₋₁<0) and rising edges (i.e. Rₙ−Rₙ₋₁>0).

The results are logical pixels 600 that have only three sub-pixels each. For a white dot and using a box filter for red and blue data, the green sub-pixels 106 are set to 100% as before. The nearby red 104, as well as the nearby blue 102, could be all set to 50%. The resample operation of inter-color-plane-phase relationship 610 of FIG. 6D is very simple and inexpensive to implement, while still providing good image quality.

Both of the above data format conversion methods match the human eye by placing the center of logical pixels at the numerically superior green sub-pixels. The green sub-pixels are each seen as the same brightness as the red sub-pixel, even though half as wide. Each green sub-pixel 106 acts as though it were half the brightness of the associated logical pixel at every location, while the rest of the brightness is associated with the nearby red sub-pixel illuminated. Thus, the green serves to provide the bulk of the high resolution luminance modulation, while the red and blue provide lower resolution color modulation, matching the human eye.

The above SPR and filtering techniques can be implemented by using any combination of hardware and/or software. For example, one or more processors within a general purpose computing device can be configured to process instructions in software to implement the above techniques. Furthermore, an application specific integrated circuit—e.g., programmed using VERILOG®—can be configured to implement the techniques disclosed herein. Such hardware and/or software may be implemented within a display system or a computing system coupled to a display.

While the invention has been described with reference to exemplary embodiments, it will be understood that various changes may be made and equivalents may be substituted for elements thereof without departing from the scope of the invention. In addition, many modifications may be made to adapt a particular situation or material to the teachings without departing from the essential scope thereof. For example, some of the embodiments above may be implemented in other display technologies such as Organic Light Emitting Diode (OLED), ElectroLumenscent (ELD), Electrophoretic (EPD), Active Matrix Liquid Crystal Display (AMLCD), Passive Matrix Liquid Crystal display (PMLCD), Incandescent, solid state Light Emitting Diode (LED), Plasma Display Panel (PDP), Field Emission (FED), and Micro-Electro/Mechanical System (MEMS). Therefore, it is intended that the invention not be limited to the particular embodiment disclosed as the best mode contemplated for carrying out this invention, but that the invention will include all embodiments falling within the scope of the appended claims.

what is claimed is:

1. In a display comprising a plurality of color sub-pixels formed across said display to form a plurality of color stripes, said display further comprising a plurality of a repeating sub-pixel group; said sub-pixel group further comprising four sub-pixels;
wherein each said sub-pixel is one of a first color sub-pixel, a second color sub-pixel and a third color sub-pixel;
wherein said sub-pixel group further comprises two sub-pixels of said first color, one sub-pixel of said second color and one sub-pixel of said third color; and
wherein said sub-pixels of each said first color, said second color and said third color each form substantially a color stripe.

2. The display as recited in claim 1 wherein said first color comprises a green color and each said second color and said third color comprises one of a red color and a blue color, respectively.

3. The display as recited in claim 1 wherein said first color comprises a red color and each said second color and said third color is one of a green color and a blue color, respectively.

4. The display as recited in claim 1 wherein said sub-pixels of said first color has a smaller area than said sub-pixels of said second color and said third color.

5. The display as recited in claim 1 where said sub-pixel group further comprises substantially one row and four columns of sub-pixels; and
wherein a first set of two non-adjacent columns comprise two sub-pixels of said first color and a second set of two non-adjacent columns comprise one sub-pixel of said second color and one sub-pixel of said third color respectively.

6. The display as recited in claim 5 wherein at least one of said two non-adjacent columns comprising two sub-pixels of said first color are offset vertically from said two non-adjacent columns comprising one sub-pixels of said second color and one sub-pixels of said third color respectively

7. The display as recited in claim 1 wherein said display is one of a group, said group comprising Active Matrix Liquid Crystal Display (AMLCD), Passive Matrix Liquid Crystal Display (PMLCD), Liquid Crystal Display (LCD), Organic Light Emitting Diode (OLED), ElectroLumenscent (ELD), Field Emission (FED), Electrophoretic (EPD), Micro-Electro/Mechanical System (MEMS), flat matrix CRT, and plasma display.

8. The display as recited in claim 7 wherein one of said LCD type dispalys applies a dot inversion scheme for driving the sub-pixels in each sub-pixel group.

9. The display as recited in claim 8 wherein said dot inversion scheme is 1×1 dot inversion.

10. The display as recited in claim 8 wherein said dot inversion scheme is 2×1 dot inversion.

11. The display as recited in claim 8 wherein said display applies a line inversion scheme for driving the sub-pixels in each sub-pixel group.

12. The display as recited in claim 1 wherein said sub-pixels of said first color has a different dimension than said sub-pixels of said second color and said third color.

13. In a display, said display comprising a plurality of a repeating sub-pixel group; said sub-pixel group further comprising four sub-pixels; wherein each said sub-pixel is one of a first color sub-pixel, a second color sub-pixel and a third color sub-pixel; wherein said sub-pixel group further comprises two sub-pixels of said first color, one sub-pixel of said second color and one sub-pixel of said third color; wherein further said sub-pixels of said first color, said second color and said third color form substantially a plurality of color stripes across said display;
a method of converting a source pixel data of a first format for rendering onto said display comprising:
determining implied sample areas for each data point of incoming three-color pixel data;
determining the resample area for each color sub-pixel in the display;
forming a set of coefficients for each the resample area, said coefficients comprising fractions whose denominators are a function of the resample area and the numerators are a function of an area of each the implied sample areas that may partially overlap said resample areas;
multiplying the incoming pixel data for each implied sample area by the coefficient resulting in a product; and
adding each the product to obtain luminance values for each resample area.

14. The method as recited in claim 13 wherein determining the resample area further comprises:
determining a phase relationship between the resample area for each color sub-pixel.

15. The methods as recited in claim 14 wherein determining a phase relationship further comprises:
positioning resample points for each said color resample areas such that the resample points for said second color and said third color substantially overlay the resample points for said first color.

16. The method as recited in claim 13 wherein said first color is green, and said second and third colors are red and blue respectively;
wherein said green color plane conversion comprises a unity filter and the red and blue color plane use a 3×3 filter coefficient matrix.

17. The method as recited in claim 16 wherein said green color plane comprises a unity filter centered to match substantially an input pixel by adjusting said filter with respect to the sub-pixel grid.

18. In a display, said display comprising a plurality of a repeating sub-pixel group; said sub-pixel group further comprising four sub-pixels; wherein each said sub-pixel is one of a first color sub-pixel, a second color sub-pixel and a third color sub-pixel; wherein said sub-pixel group further comprises two sub-pixels of said first color, one sub-pixel of said second color and one sub-pixel of said third color; wherein further said sub-pixels of said first color, second color and said sub-pixels of said third color form substantially a color stripe across said display;
a method of converting a source pixel data of a first format for rendering onto said display comprising:
inputting a set of color image data;
testing the input data for a plurality of conditions; and
taking appropriate actions in response to the outcome of said testing of the input data.

19. The method as recited in claim 18 wherein said set of color image input data comprises a sample of a 1×3 matrix of input data.

20. The method as recited in claim 18 wherein said set of color image input data comprises a sample of a 1×2 matrix of input data.

21. The method as recited in claim 18 wherein testing the input data for a plurality of conditions further comprises:
testing for the detection of a high contrast feature in the input data.

22. The method as recited in claim 21 wherein said high contrast feature comprises one of a group, said group comprising an edge, a line, and a dot.

23. The method as recited in claim 18 wherein taking appropriate actions in response to the outcome of said testing of the input data further comprises:
substitute a new color data value for the current color data value.

24. The method as recited in claim 18 wherein taking appropriate actions in response to the outcome of said testing of the input data further comprises:
apply gamma correction to the current color data value.

25. The method as recited in claim 18 wherein taking appropriate actions in response to the outcome of said testing of the input data further comprises:
apply new sub-pixel rendering filter coefficients to the input data.

26. A system comprising:
a display, said display comprising a plurality of a repeating sub-pixel group; said sub-pixel group further comprising four sub-pixels; wherein each said sub-pixel is one of a first color sub-pixel, a second color sub-pixel and a third color sub-pixel; wherein said sub-pixel group further comprises two sub-pixels of said first color, one sub-pixel of said second color and one sub-pixel of said third color; wherein further said sub-pixels of said first color, said second color and said third color form substantially a color stripe across said display; and
a processor for sub-pixel rendering input image data.

27. The system as recited in claim 26 wherein said processor is to input a set of color image data, test the input data for a plurality of conditions; and take appropriate actions in response to the outcome of said testing of the input data.

28. The system as recited in claim 27 wherein said set of color image input data comprises a sample of a 1×3 matrix of input data.

29. The system as recited in claim 27 wherein said set of color image input data comprises a sample of a 1×2 matrix of input data.

30. The system as recited in claim 27 wherein said processor is to test for the detection of a high contrast feature in the input data.

31. The system as recited in claim 30 wherein said high contrast feature comprises one of a group, said group comprising an edge, a line, and a dot.

32. The system as recited in claim 27 wherein said processor is to substitute a new color data value for the current color data value.

33. The system as recited in claim 27 wherein said processor is to apply gamma correction to the current color data value.

34. The system as recited in claim 27 wherein said processor is to apply new sub-pixel rendering filter coefficients to the input data.

35. The system as recited in claim 26 wherein said processor is to determine implied sample areas for each data point of incoming three-color pixel data, to determine the resample area for each color sub-pixel in the display, to form a set of coefficients for each resample area, said coefficients comprising fractions whose denominators are a function of the resample area and the numerators are a function of an area of each of the implied sample areas that may partially overlap said resample areas, to multiply the incoming pixel data for each implied sample area by the coefficient resulting in a product, and to add each of the product to obtain luminance values for each resample area.

36. The system as recited in claim 35 wherein said processor is to determine a phase relationship between the resample area for each color sub-pixel.

37. The system as recited in claim 36 wherein said processor is to position resample points for each said color resample areas such that the resample points for said second color and said third color substantially overlay the resample points for said first color.

38. The system as recited in claim 35 wherein said first color is green, and said second and third colors are red and blue respectively; and
wherein said green color plane conversion comprises a unity filter and the red and blue color plane use a 3×3 filter coefficient matrix.

39. The system as recited in claim 38 wherein said green color plane comprises a unity filter centered to match substantially an input pixel by adjusting said filter with respect to the sub-pixel grid.

40. A computing device for converting a source pixel data of a first format for rendering on a display, said display comprising a plurality of a repeating sub-pixel group; said sub-pixel group further comprising four sub-pixels; wherein each said sub-pixel is one of a first color sub-pixel, a second color sub-pixel and a third color sub-pixel; wherein said sub-pixel group further comprises two sub-pixels of said first color, one sub-pixel of said second color and one sub-pixel of said third color; wherein further said sub-pixels of said first color, said second color and said third color form substantially a plurality of color stripes across said display, the computing device comprising:
a memory to store the source pixel data; and
a processor configured to:
determine implied sample areas for each data point of incoming three-color pixel data from the source pixel data,
determine the resample area for each color sub-pixel in the display,
form a set of coefficients for each the resample area, said coefficients comprising fractions whose denominators are a function of the resample area and the numerators are a function of an area of each the implied sample areas that may partially overlap said resample areas,
multiply the incoming pixel data for each implied sample area by the coefficient resulting in a product, and
add each the product to obtain luminance values for each resample area.

41. A computing device for converting a source pixel data of a first format for rendering on a display, said display comprising a plurality of a repeating sub-pixel group; said sub-pixel group further comprising four sub-pixels; wherein each said sub-pixel is one of a first color sub-pixel, a second color sub-pixel and a third color sub-pixel; wherein said sub-pixel group further comprises two sub-pixels of said first color, one sub-pixel of said second color and one sub-pixel of said third color; wherein further said sub-pixels of said first color, second color and said sub-pixels of said third color form substantially a color stripe across said display, the computing device comprising:
a memory to store the source pixel data;
a processor configured to:
input a set of color image data from the source pixel data,
test the inputted data for a plurality of conditions, and
take appropriate actions in response to the outcome of said testing of the inputted data.
